(19) United States
(12) Patent Application Publication
(10) Pub. No.: US 2016/0347580 A1
(43) Pub. Date: Dec. 1, 2016

(54) ARRANGEMENT AND A METHOD FOR INSTALLING OR UNINSTALLING ELEVATOR ROPES

(71) Applicant: Antti MERTALA, Hyvinkaa (FI)

(72) Inventor: Antti MERTALA, Hyvinkaa (FI)

(73) Assignee: Kone Corporation, Helsinki (FI)

(21) Appl. No.: 15/140,642

(22) Filed: Apr. 28, 2016

(30) Foreign Application Priority Data
May 25, 2015 (EP) 15169081.5

(51) Int. Cl. B66B 19/02

(52) U.S. Cl. CPC B66B 19/02

(57) ABSTRACT

The arrangement for installing or uninstalling elevator ropes comprises at least one rope reel and a rope reel unit comprising a frame and at least one rotating rope feed member. The at least one rotating rope feed member is driven by an electric drive unit comprising an electric motor and a gear, the electric motor being driven by a frequency converter by which the torque of the electric motor is adjustable continuously. The feeding of at least one rope from the at least one rope reel is controlled directly or indirectly by the at least one rope feed member.

This application claims priority to European Patent Application No. 15169081.5 filed on May 25, 2015, the entire contents of which are incorporated herein by reference.

### FIELD OF THE INVENTION

The invention relates to an arrangement and a method for installing or uninstalling elevator ropes.

### BACKGROUND ART

An elevator comprises an elevator car, lifting machinery, ropes, and a counter weight. The elevator car is supported on a transport frame being formed by a sling or a car frame. The transport frame surrounds the elevator car. The lifting machinery comprises a sheave, a machinery brake and an electric motor for rotating the sheave. The lifting machinery moves the car upwards and downwards in a vertically extending elevator shaft. The transport frame and thereby also the elevator car are carried by the ropes, which connect the elevator car to the counter weight. The transport frame of the elevator car is further supported with gliding means at guide rails extending in the vertical direction in the elevator shaft. The gliding means can comprise rolls rolling on the guide rails or gliding shoes gliding on the guide rails when the elevator car is mowing upwards and downwards in the elevator shaft. The guide rails are supported with support means on the side wall structures of the elevator shaft. The gliding means engaging with the guide rails keep the elevator car in position in the horizontal plane when the elevator car moves upwards and downwards in the elevator shaft. The counter weight is supported in a corresponding way on guide rails supported with support means on the wall structure of the elevator shaft. The elevator car transports people and/or goods between the landings in the building. The elevator shaft can be formed so that the wall structure is formed of solid walls or so that the wall structure is formed of an open steel structure.

When an elevator installation in a high rise building is performed, the roping process requires a lot of manual work. The ropes are in a new elevator installation positioned on rope reels and are then reeled from the rope reels to the shaft. The old ropes are in a replacement of ropes reeled on empty reels. The rope reels are driven manually i.e. a fitter rotates and controls the rope reels.

When installing new ropes, one to ten ropes can be lifted simultaneously depending on the weight of the ropes. One fitter can control the rolling of maximum four rope reels. The fitter controls and keeps the reel rolling speeds in each rope reel on such a level that the ropes are kept on a desired tightness on their way to the elevator shaft. The idea is to avoid unnecessary slack in the ropes when they pass to the elevator shaft.

When uninstalling old ropes, one to ten ropes can be removed simultaneously depending on the weight of the ropes. The fitter is rolling the reel manually and one fitter can roll one to two reels. The fitter rolls the reels so that the old ropes are removed from the shaft and reeled on the empty reel that he is rolling. The number of fitters that are available limits the number of ropes that can be changed on one run. It is possible to roll several ropes on one reel, but the ropes have to be cut when the reel gets full and then one has to continue on the next reel.

### BRIEF DESCRIPTION OF THE INVENTION

An object of the present invention is to save manual work during the installation and/or replacement of ropes in an elevator.

The arrangement for installing or uninstalling elevator ropes is defined in claim 1.

The arrangement for installing or uninstalling elevator ropes comprising at least one rope reel and a rope reel unit comprising a frame and at least one rotating rope feed member. The at least one rotating rope feed member is driven by an electric drive unit comprising an electric motor and a gear, the electric motor being driven by a frequency converter by which the torque of the electric motor is adjustable continuously, whereby the feeding of at least one rope from the at least one rope reel is controlled directly or indirectly by the at least one rope feed member.

The method for installing or uninstalling elevator ropes is defined in claim 10.

The method for installing or uninstalling elevator ropes comprises the steps of:

feeding at least one rope from at least one rope reel over a traction sheave to an elevator shaft or feeding the at least one rope in the opposite direction,

controlling the feeding of the at least one rope directly or indirectly with a rope reel unit comprising a frame and at least one rotating rope feed member, whereby the at least one rotating rope feed member is driven by an electric drive unit comprising an electric motor and a gear, the electric motor being driven by a frequency converter by which the torque of the electric motor is adjustable continuously.

The invention makes it possible to control the rope feeding effectively in an elevator rope reeling process.

The invention makes it also possible to control the rope reeling from several rope reels with one rope reeling unit.

### BRIEF DESCRIPTION OF THE DRAWINGS

The invention will in the following be described in greater detail by means of preferred embodiments with reference to the attached drawings, in which:

FIG. 1 shows a vertical cross section of an elevator,

FIG. 2 shows a horizontal cross section of the elevator,

FIG. 3 shows an arrangement for installing or uninstalling elevator ropes according to a first embodiment of the invention,

FIG. 4 shows an arrangement for installing or uninstalling elevator ropes according to a second embodiment of the invention,

FIG. 5 shows an arrangement for installing or uninstalling elevator ropes according to a third embodiment of the invention.

### DETAILED DESCRIPTION OF EMBODIMENTS OF THE INVENTION

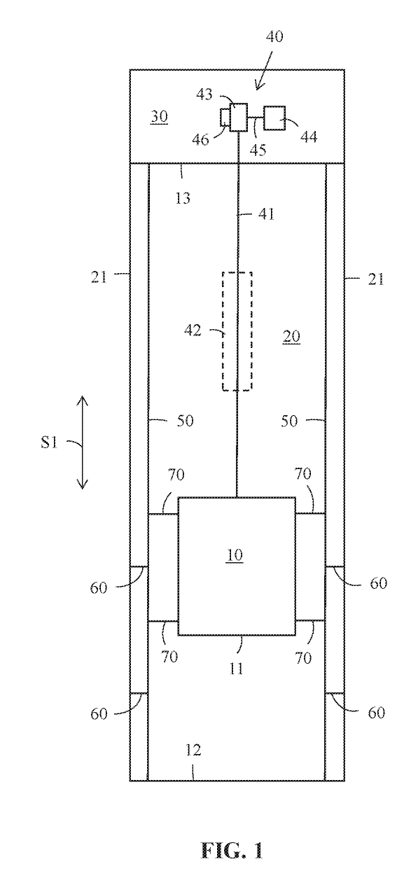

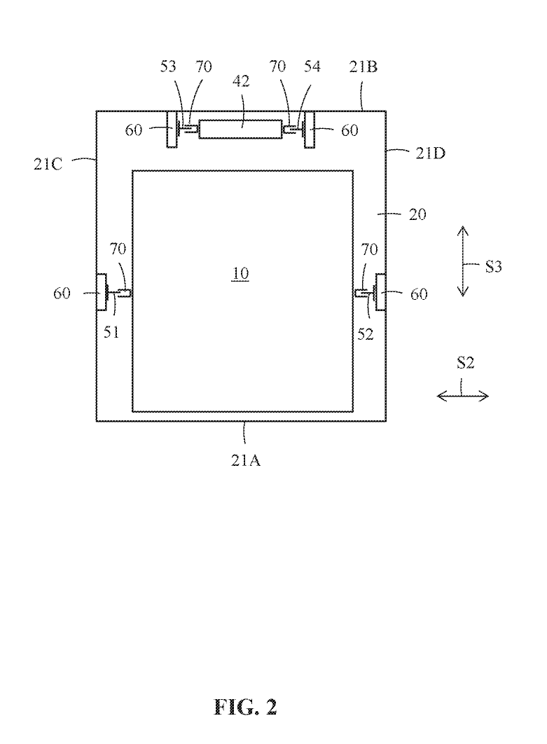

FIG. 1 shows a vertical cross section and FIG. 2 shows a horizontal cross section of an elevator.

The elevator comprises a car 10, an elevator shaft 20, a machine room 30, lifting machinery 40, ropes 41, and a counter weight 42. The car 10 is supported on a sling 11 or transport frame surrounding the car 10. The lifting machinery 40 comprises a traction sheave 43, an electric motor 44 for rotating the traction sheave 43 via a shaft 45, and a machinery brake 46 for braking the rotation of the traction sheave 45. The lifting machinery 40 moves the car 10 in a first direction S1 upwards and downwards in a vertically extending elevator shaft 20. The sling 11 and thereby also the elevator car 10 are carried by the ropes 41, which connect the elevator car 10 to the counter weight 42. The sling 11 and thereby also the elevator car 10 is further supported with gliding means 70 at guide rails 50 extending in the vertical direction in the elevator shaft 20. There are two guide rails 51, 52 for the elevator car 10. The elevator car guide rails 51, 52 are positioned on opposite side walls 21C, 21D of the shaft 20. The gliding means 70 can comprise rolls rolling on the guide rails 50 or gliding shoes gliding on the guide rails 50 when the elevator car 10 is mowing upwards and downwards in the elevator shaft 20. There are further two guide rails 53, 54 for the counter weight 42 positioned on the back wall 21B of the shaft 20. The counter weight 42 is supported with corresponding gliding means 70 on the counter weight guide rails 53, 54.

The guide rails 50 are fastened with support means 60 at the walls 21B, 21C, 21D of the shaft 20. The figure shows only two support means 60, but there are several support means 60 along the height of each guide rail 50. The cross section of the guide rails 50 may have the form of a letter T. The vertical branch of the guide rail element 50 forms three gliding surfaces for the gliding means 70 comprising rolls or gliding shoes. There are thus two opposite side gliding surfaces and one front gliding surface in the guide rail 50. The cross-section of the gliding means 70 has the form of a letter U so that the inner surface of the gliding means 70 sets against the three gliding surfaces of the guide rail 50. The gliding means 70 are attached to the sling 11 and/or to the counter weight 42.

The elevator shaft 20 can be formed so that the walls 21A, 21B, 21C, 21D are formed of solid walls or so that the walls 21A, 21B, 21C, 21D are formed of an open steel structure.

The figures show a first direction S1, which is a vertical direction in the elevator shaft 20, a second direction S2, which is the direction between the guide rails (DBG) and a third direction S3, which is the direction from the back wall 21B to the front wall 21A in the shaft 20 (BTF). The second direction S2 is perpendicular to the third direction S3.

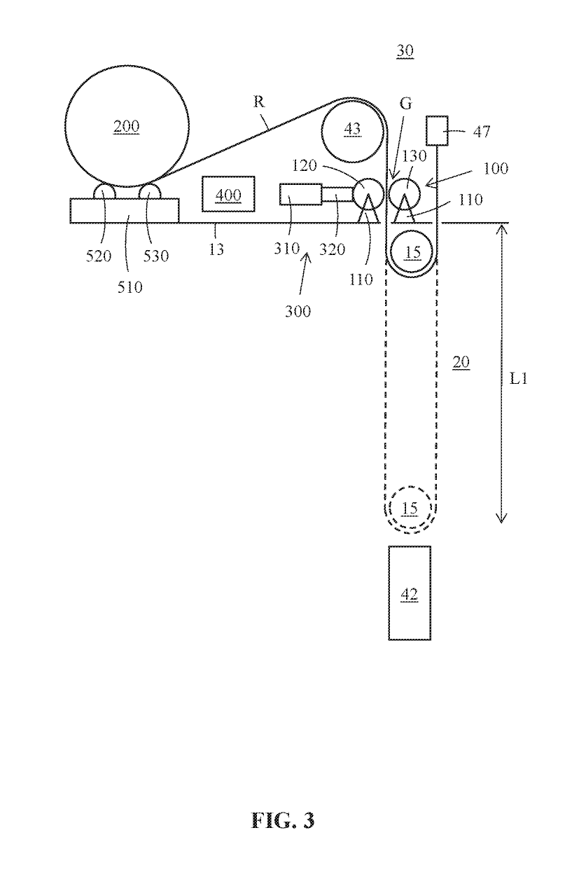

FIG. 3 shows an arrangement for installing or installing elevator ropes according to a first embodiment of the invention. The arrangement comprises a rope reel 200 and a rope reeling unit 100. The rope reel 200 is supported through two support rollers 520, 530 on a support frame 510. The support rollers 520, 530 are rotatably supported on the support frame 510. Both support rollers 520, 530 rotate freely i.e. they are not driven. The rope reeling unit 100 comprises a frame 110, two rotating rope feed members 120, 130 in the form of rollers and an electric drive unit 300. The rope reel 200 and the rope reeling unit 100 are at a distance from each other. The rope R runs from the rope reel 200 over the traction sheave 43 of the elevator machinery to a gap G between the two rollers 120, 130 and further downwards to the elevator shaft 20. The two rollers 120, 130 rotate in opposite directions. The first end of the rope R runs around a counter weight suspension sheave 15 and further upwards to the machine room 30 where the first end of the rope R is fixed at a fixing point 47. At least one 120 of the two rollers 120, 130 is driven by the electric drive unit 300 comprising an electric motor 310 and a gear 320. It might, however, be advantageous to drive both rollers 120, 130 with the electric drive unit 300. The electric motor 310 is driven by a frequency converter 400 by which the torque or the rotation speed of the electric motor 310 can be adjusted continuously. The rope reel 200, the support rollers 520, 530, the support frame 510, the traction sheave 43, the rollers 120, 130, the electric drive 300 and the frequency converter 400 are positioned in the machine room 30 above the elevator shaft 20. The rotation speed of the rollers 120, 130 forming rope feed members can be regulated continuously by regulating the rotation speed of the electric motor 310 with the frequency converter 400. The length L1 of the rope loop in the elevator shaft 20 can be increased in a controlled way by feeding rope R through the rollers 120, 130 into the elevator shaft 20. The counter weight suspension sheave 15 positioned within the rope loop will be lowered in the elevator shaft 20 as the length L1 of the rope loop increases. The counter weight suspension sheave 15 is lowered to the height of the counter weight 42 positioned at the bottom 12 of the elevator shaft 20. The counter weight suspension sheave 15 can then be attached to the fixing means positioned at the upper end of the counter weight 42. The second opposite end of the rope R will after the traction sheave 43 run around the car suspension sheave or sheaves after which said second end of the rope R is fixed at a fixing point in the machine room 30. The elevator roping system will thus be a 2:1 elevator roping system.

Several adjacent rope reels 200 can be situated on the support frame 510. The ropes R of all the rope reels 200 can be fed simultaneously through the rope reeling unit 100. Only one rope reeling unit 100 is thus needed to control the reeling of several ropes R.

The arrangement shown in FIG. 3 can advantageously be used in reeling belt shaped ropes having a greater width compared to the thickness of the rope. The width to thickness ratio in these belt shaped ropes is typically at least 2. Such ropes comprise a coating and a plurality of adjacent parallel load bearing members embedded in the coating and running along the longitudinal direction of the rope. The load bearing members bear the load exerted on the rope R in the longitudinal direction of the rope R. The coating forms the outer surface of the rope R and extends between adjacent load bearing members thereby isolating them from each other. The load bearing members are preferably made of composite material comprising reinforcing fibers in a polymer matrix. The coating is preferably of a material having a fairly high friction so that the rollers 120, 130 get a good grip of the outer surface of the rope. Polyuretan could be used as the coating material. The rope R is in the form of a straight rod when no external forces are acting on the rope R. The rope R is therefore advantageously stored on a reel having a circular side plate and a cylindrical support surface so that one end of the cylinder is attached to the cylindrical side plate. The rope R can be wounded into the reel starting from the outer turns setting against the cylindrical support surface. The rope R is also rather stiff which means that rollers 120, 130 are needed in the position shown in FIG. 3 in order to direct the rope R downwards after the traction sheave 43.

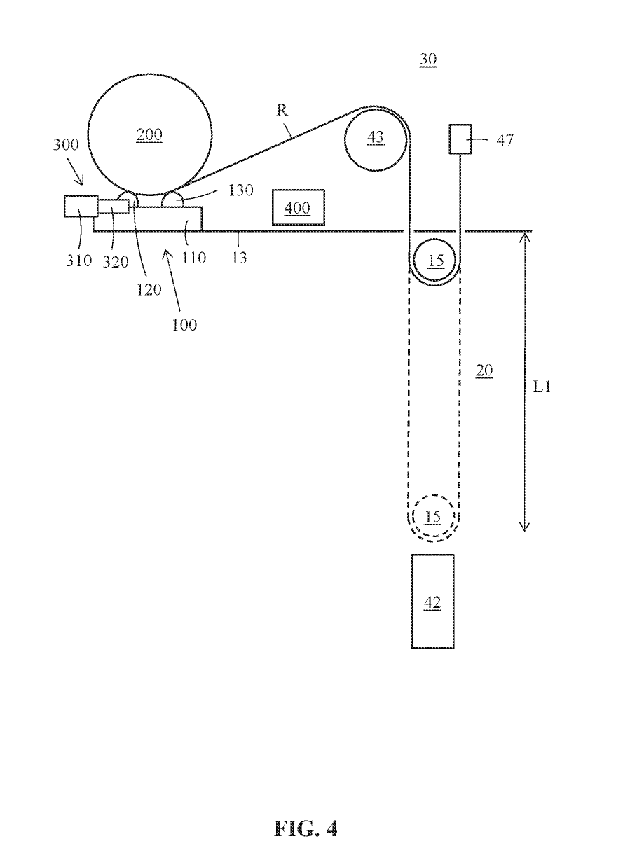

FIG. 4 shows an arrangement for installing or uninstalling elevator ropes according to a second embodiment of the invention. The rope reeling unit 100 is in this embodiment moved from a position above the opening after the traction sheave 43 to a position under the rope reel 200. The rope reeling unit 100 comprises in the same way as in the embodiment shown in FIG. 3 a frame 110 provided with two rope feed members 120, 130 at a distance from each other. The rope feed members 120, 130 are formed of rollers being rotatably supported on the frame 110. At least one 130 of the rollers 120, 130 is driven by an electric drive unit 300 comprising and electric motor 310 and a gear 320. It might be advantageous to have both rollers 120, 130 driven by the electric drive unit 300. The electric motor 310 is driven by a frequency converter 400 by which the torque or the rotation speed of the electric motor 310 can be adjusted continuously. The load of the electric motor 310 determines the magnitude of the torque in rotation speed control. The load of the electric motor 310 determines the rotation speed of the electric motor in torque control. A rope reel 200 is supported on the rollers 120, 130 in the rope reeling unit 100. The outer circumference of the rope reel 200 rests on the rollers 120, 130. The length of the rope reeling unit 100 measured in the axial direction of the rollers 120, 130 can be such that several rope reels 200 can be positioned adjacent to each other on rollers 120, 130 in one rope reeling unit 100. This means that several rope reels 200 can be controlled with one rope reeling unit 100. The length of the rope reeling unit 100 measured in the axial direction of the rollers 120, 130 can also be made adjustable.

The rope reeling process corresponds as such to the rope reeling process described in FIG. 3. The rope reeling unit 100 controls now directly the rotation of the rope reel 200 and thereby indirectly the reeling of the rope R. The rope reeling unit 100 controls in FIG. 3 directly the reeling of the rope R and indirectly the rotation of the rope reel 200.

The arrangement shown in FIG. 4 can advantageously be used in reeling twisted steel ropes having a more or less round cross section.

Guide rollers could be used in guiding the rope R after the traction sheave 43 through the opening in the floor of the machine room 30 if needed. These guide rollers would not be driven.

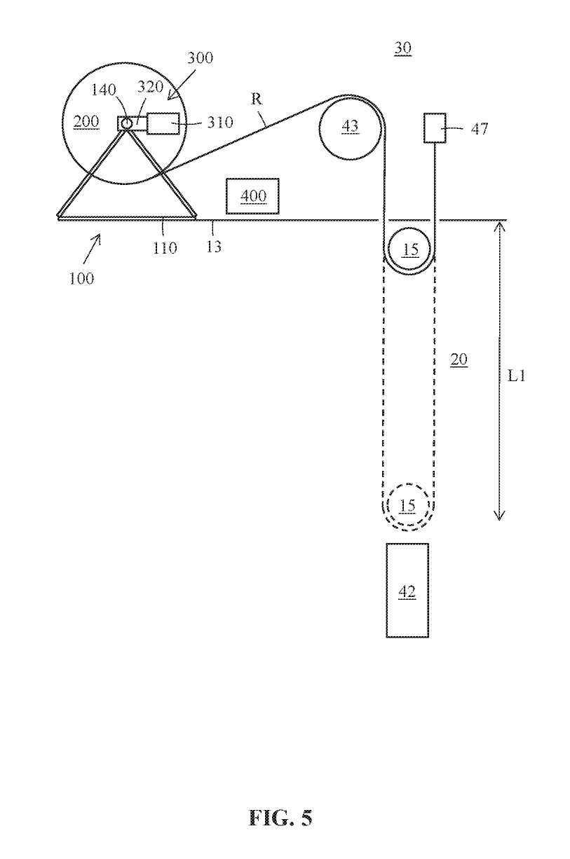

FIG. 5 shows an arrangement for installing or uninstalling elevator ropes according to a third embodiment of the invention. This elevator rope reeling unit 100 is a modification of the rope reeling unit 100 shown in FIG. 4. The rope reeling unit 100 comprises a frame 110 that supports a rotating rope feed member 140. The rotating rope feed member 140 is formed of a shaft passing through a hole in the middle of the rope reel 200. Both ends of the shaft 140 are rotatably supported on the frame 110. The shaft 140 is driven by an electric drive unit 300 comprising an electric motor 310 and a gear 320. The electric motor 310 is driven by a frequency converter 400 by which the torque or the rotation speed of the electric motor 310 can be adjusted continuously. A rope reel 200 is supported on the shaft 140 in the rope reeling unit 100 so that the rope reel 200 rotates with the shaft 140. The length of the rope reeling unit 100 measured in the axial direction of the shaft 140 can be such that several rope reels 200 can be positioned adjacent to each other on the shaft 140 in one rope reeling unit 100. This means that several rope reels 200 can be controlled with one rope reeling unit 100. The length of the rope reeling unit 100 measured in the axial direction of the shaft 140 can also be made adjustable.

The rope reeling process corresponds as such to the rope reeling process described in FIG. 3. The rope reeling unit 100 controls now directly the rotation of the rope reel 200 via the shaft 140 and thereby indirectly the reeling of the rope R. The rope reeling unit 100 controls in FIG. 3 directly the reeling of the rope R and indirectly the rotation of the rope reel 200.

The rope reeling unit shown in FIG. 5 can advantageously be used in reeling twisted steel ropes having a more or less round cross section.

The arrangement and the method according to the invention can be used when new ropes are to be installed into the elevator shaft and when old ropes are to be replaced by new ropes in the elevator shaft. When uninstalling i.e. reeling old ropes onto the rope reel 200 the electric drive unit 300 rotates the rope reel 200 and keeps the torque acting on the rope reel 200 constant. The rotation speed of the rope reel 200 is not a good target for the frequency converter 400 in this case. This is due to the fact that the radius of the rope layer on the rope reel 200 changes when the amount of rope changes on the rope reel 200.

The arrangement and the method can be used in a 2:1 elevator roping system or in a higher order elevator roping system.

The elevator could have a hoisting height of over 30 meters, preferably 30-80 meters, most preferably 40-80 meters.

The elevator could on the other hand have a hoisting height of over 75 meters, preferably over 100 meters, more preferably over 150 meters, most preferably over 250 meters. In elevators with a great hoisting height long ropes have to be used, whereby the weight of the ropes becomes considerable. This makes the use of the invention even more advantageous as the reeling of the ropes can easily be controlled in reliable manner by only one or maybe two fitters.

The use of the invention is naturally not limited to the type of elevator disclosed in the figures. The invention can be used in any type of elevator e.g. also in elevators lacking a machine room and/or a counterweight. The counter weight could be positioned on the back wall or on at either side wall of the elevator shaft or on both side walls of the elevator shaft. The lifting machinery could be positioned at the top of the elevator shaft or at the bottom of the elevator shaft or within the elevator shaft at either side wall of the elevator shaft.

It will be obvious to a person skilled in the art that, as the technology advances, the inventive concept can be implemented in various ways. The invention and its embodiments are not limited to the examples described above but may vary within the scope of the claims.

1. An arrangement for installing or uninstalling elevator ropes comprising at least one rope reel and a rope reel unit comprising a frame and at least one rotating rope feed member, wherein the at least one rotating rope feed member is driven by an electric drive unit comprising an electric motor and a gear, the electric motor being driven by a frequency converter by which the torque of the electric motor is adjustable continuously, whereby the feeding of at least one rope from the at least one rope reel is controlled directly or indirectly by the at least one rope feed member.

2. An arrangement according to claim 1, wherein the arrangement comprises several rope reels, whereby the rope reeling of the ropes from all the rope reels is controlled by the same rope reel unit.

3. An arrangement according to claim 1, wherein the at least one rope feed member is formed by two rollers forming a gap between them, said rollers being rotatably supported on the frame and at least one of the rollers being driven by the electric motor, whereby the at least one rope from the at least one rope reel passes through the gap, the at least one rope being slightly pressed between the two rollers enabling feeding of the at least one rope by rotating the rollers.

4. An arrangement according to claim 3, wherein the at least one rope to be installed is a belt shaped rope having a greater width compared to the thickness of the rope, the width to thickness ratio being advantageously at least 2.

5. An arrangement according to claim 1, wherein the at least one support member is formed by two rollers rotatably supported on the frame and positioned at a distance from each other, the rope reel being supported on the rollers, whereby at least one of the rollers is driven by the electric motor.

6. An arrangement according to claim 1, wherein the at least one support member is formed by a shaft rotatably supporting the rope reel, whereby the shaft is driven by the electric motor.

7. An arrangement according to claim 5, wherein the rope to be installed is a twisted steel rope.

8. An arrangement according to claim 1, wherein the arrangement is used in a 2:1 elevator roping system or in a higher order elevator roping system.

9. An arrangement according to claim 1, wherein the arrangement is used in an elevator shaft in a high rise building having a hoisting height of over 75 meters, preferably over 100 meters, more preferably over 150 meters, most preferably over 250 meters.

10. A method for installing or uninstalling elevator ropes comprising the step of feeding at least one rope from at least one rope reel over a traction sheave to an elevator shaft or feeding the at least one rope in the opposite direction,
wherein the further step of:
controlling the feeding of the at least one rope directly or indirectly with a rope reel unit comprising a frame and at least one rotating rope feed member, whereby the at least one rotating rope feed member is driven by an electric drive unit comprising an electric motor and a gear, the electric motor being driven by a frequency converter by which the torque of the electric motor is adjustable continuously.

11. A method according to claim 10, wherein the rope reel unit is used to control the reeling of the ropes from several rope reels.

12. A method according to claim 10, wherein the further steps of:
arranging the rope reel unit after the traction sheave in connection with a rope opening leading to the elevator shaft, the rope reel unit being formed of two rollers rotatably supported on a frame, said two rollers forming the at least one rotating rope feed member, at least one of the two rollers being driven by the electric motor,
feeding the at least one rope from the at least one rope reel over the traction sheave through a gap formed between the two rollers and further through the rope opening to the elevator shaft,
controlling the feeding of the at least one rope by adjusting the torque of the electric motor with the frequency converter.

13. A method according to claim 12, wherein the at least one rope to be installed is a belt shaped rope having a greater width compared to the thickness of the rope, the width to thickness ratio being advantageously at least 2.

14. A method according to claim 10, wherein the further steps of:
arranging the rope reel unit in connection with the rope reel, the at least one rotating rope feed member being formed of two rollers rotatably supported on a frame, at least one of the two rollers being driven by the electric motor, the at least one rope reel being supported on the rollers so that the rope reel rotates with the rollers,
feeding the at least one rope from the at least one rope reel over the traction sheave through the rope opening to the elevator shaft,
controlling the feeding of the at least one rope by adjusting the torque of the electric motor with the frequency converter.

15. A method according to claim 10, wherein the further step of:
arranging the rope reel unit in connection with the at least one rope reel, the at least one rotating rope feed member being formed of a shaft rotatably supporting the at least one rope reel, the shaft being driven by the electric motor,
feeding the at least one rope from the at least one rope reel over the traction sheave through the rope opening to the elevator shaft,
controlling the feeding of the at least one rope by adjusting the torque of the electric motor with the frequency converter.

16. A method according to claim 14, wherein the at least one rope to be installed is a twisted steel rope.

17. A method according to claim 10, wherein the further step of:
passing the at least one rope in the elevator shaft under a counter weight sheave and back up to a top of the elevator shaft, whereby the end of the at least one rope is fixed at the top of the elevator shaft.

18. A method according to claim 17, wherein the further step of:
feeding the at least one rope into the elevator shaft, whereby the length of the at least one rope loop increases in the elevator shaft and the counter weight sheave is lowered towards the counter weight positioned at a bottom of the elevator shaft.

19. A method according to claim 10, wherein the step of using the method in a 2:1 elevator roping system or in a higher order elevator roping system.

20. A method according to claim 10, wherein the step of using the method in an elevator shaft in a high rise building having a hoisting height of over 75 meters, preferably over 100 meters, more preferably over 150 meters, most preferably over 250 meters.
